(19) United States
(12) Patent Application Publication
(10) Pub. No.: US 2024/0082778 A1
(43) Pub. Date: Mar. 14, 2024

(54) Compositions, Systems, and Methods for Sequestering CO2 from Combustion Flue Gas

(71) Applicant: CARBONQUEST, INC., Spokane Valley, WA (US)

(72) Inventor: William A. Fuglevand, Spokane Valley, WA (US)

(73) Assignee: CARBONQUEST, INC., Spokane Valley, WA (US)

(21) Appl. No.: 18/515,097

(22) Filed: Nov. 20, 2023

Related U.S. Application Data
(63) Continuation-in-part of application No. PCT/US22/33871, filed on Jun. 16, 2022.
(60) Provisional application No. 63/211,484, filed on Jun. 16, 2021.

(51) Int. Cl. B01D 53/02; B01J 20/22

(52) U.S. Cl. CPC B01D 53/02; B01J 20/226; B01D 2253/204; B01D 2256/10; B01D 2257/504

(57) ABSTRACT

Systems for recovering CO₂ from a combustion gas stream are provided. Compositions are also provided; the compositions can include: a nanoporous framework composition; a ligand associated with the nanoporous framework composition; and CO₂ associated with the one or both of the ligand and the nanoporous framework composition. Methods for separating CO₂ from a combustion stream are also provided.

### CROSS REFERENCE TO RELATED APPLICATION

This application is a Continuation-in-Part of PCT Patent Application Serial No. PCT/US22/33871 filed Jun. 16, 2022, entitled “Compositions, Systems, and Methods for Sequestering C02 from Combustion Flue Gas”, which claims priority to U.S. Provisional Patent Application Ser. No. 63/211,484 which was filed Jun. 16, 2021, entitled ““Compositions, Systems, and Methods for Sequestering CO₂ from Combustion Flue Gas”, the entirety of each of which is incorporated by reference herein.

### TECHNICAL FIELD

The field of the invention relates to the processing of building emissions that can include carbon dioxide management systems and methods, and more particularly, be utilized by multi-use or large footprint buildings that utilize large combustion energy sources for building systems such as steam heating, hot water, sorbent cooling, and combined heat and power with byproduct generation of emissions in the form of combustion streams.

### BACKGROUND

Carbon dioxide generation in buildings, particularly in large metropolitan areas and/or industrial settings, is a significant contributor to carbon dioxide generation overall. Carbon dioxide is currently listed as a global warming compound whose reduction is sought worldwide. The generation of carbon dioxide is a necessary part of respiration, which is a necessary part of life, but it is important to limit the generation of carbon dioxide in an effort to address climate change. The present disclosure provides building emission processing and sequestration systems that can address carbon dioxide generation from combustion of fossil fuels and proliferation thereof in metropolitan areas.

### SUMMARY

Systems for recovering CO₂ from a combustion gas stream are provided; the systems can include: a combustion stream having CO₂ and N₂; a vessel operatively coupled to the combustion stream, with the vessel containing a nanoporous framework composition associated with a ligand; and a vessel outlet stream operatively engaged with the vessel.

Compositions also provided; the compositions can include: a nanoporous framework composition; a ligand associated with the nanoporous framework composition; and CO₂ associated with the one or both of the ligand and the nanoporous framework composition.

Methods for separating CO₂ from combustion streams are also provided. The methods can include: charging a vessel containing a nanoporous framework composition with components of a combustion stream, at least two of the components comprising CO₂ and N₂; discharging in the first of at least two steps, at least some of the N₂ while retaining CO₂ associated with the metal organic composition; and discharging in a second of the at least two steps, at least some of the retained CO₂ to provide a stream of CO₂ substantially free of N₂.

Systems for recovering CO₂ from a combustion gas stream are also provided that can include: a combustion stream comprising CO₂ and N₂; a vessel operatively coupled to the combustion stream, the vessel containing material comprising one or more of activated carbons, carbon molecular sieves, carbon nanotubes, natural and synthetic zeolites (i.e., alkali metal aluminosilicates), aluminophosphate materials, and/or mesoporous silica; and a vessel outlet stream operatively engaged with the vessel.

Methods for separating CO₂ from a combustion stream are also provided that can include: charging a vessel with components of a combustion stream, at least two of the components comprising CO₂ and N₂; and the vessel containing an adsorbent material comprising one or more of activated carbons, carbon molecular sieves, carbon nanotubes, natural and synthetic zeolites (i.e., alkali metal aluminosilicates), aluminophosphate materials, mesoporous silica or nanoporous framework composition; discharging in the first of at least two steps, at least some of the N₂ while retaining CO₂ associated with the chosen adsorbent; and discharging in a second of the at least two steps, at least some of the retained CO₂ to a provide a stream of CO₂ substantially free of N₂.

### DRAWINGS

Embodiments of the disclosure are described below with reference to the following accompanying drawings.

FIG. 1 is depiction of a system for sequestering CO₂ from a combustion stream according to an embodiment of the disclosure.

FIGS. 2A and 2B are example adsorbents for use according to an embodiment of the disclosure.

FIGS. 2C-2F are amine functional groups as well as an amine impregnation compound for enhancing adsorbent CO₂ capacity according to an embodiment of the disclosure.

FIG. 3 is a functionalized metal organic framework (MOF) composition according to an embodiment of the disclosure.

FIG. 4A is a depiction of a metal organic structure (MOF) according to an embodiment of the disclosure.

FIG. 4B is a depiction of another metal organic structure (MOF) according to an embodiment of the disclosure.

FIG. 5 is a component of the system of FIG. 1 according to an embodiment of the disclosure.

### DESCRIPTION

This disclosure is submitted in furtherance of the constitutional purposes of the U.S. Patent Laws “to promote the progress of science and useful arts” (Article 1, Section 8).

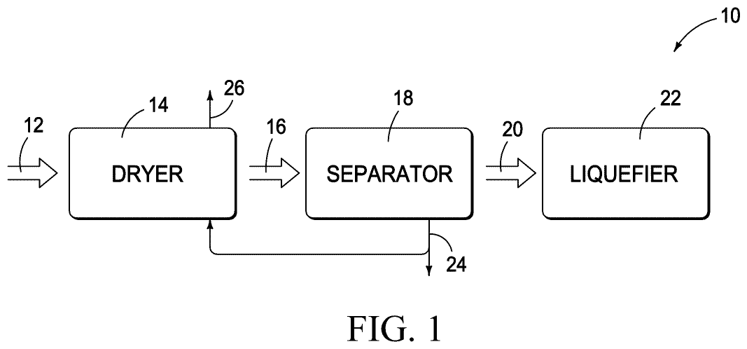

The present disclosure will be described with reference to FIGS. 1-5. Referring first to FIG. 1, a system 10 is depicted that includes three components, a dryer component 14, a separator 18, and a liquefier component 22. In accordance with example implementations, system 10 can be configured to receive a gas combustion product 12 that can be a flue gas or combustion stream from an industrial and/or residential building, for example. In accordance with example implementations, this stream 12 can include nitrogen and carbon dioxide, and at this point can be what is considered minimally wet and in need of final drying. The stream can also include O₂.

In accordance with example implementations, dryer 14 can be utilized to dry the combustion gas 12, reducing the water content. In at least one configuration, the combustion product 12, for final drying can be less than 0.1% water. In accordance with another example configuration, the dryer can be configured to receive a stream 24 that comprises at least some nitrogen that can be recovered from separator 18. In accordance with example configurations, dryer 14 can be operatively engaged with the nitrogen feed to be configured to regenerate desiccant within the dryer. Typically, the dryer can be a two-chamber cycle device, wherein one chamber is drying while the other chamber is re-generating for drying, and those cycles can run continuously. In accordance with example implementations, the nitrogen used to dry the desiccant after the desiccant is exhausted (no longer removing water) in the process of regenerating the desiccant can be provided from the separator 18. Upon drying, the dried combustion product can include primarily nitrogen, oxygen, and carbon dioxide, and less than about 10 ppm water before being provided to separator 18.

Separator 18 can be a Pressure Swing Adsorption assembly that includes an adsorbent within a vessel of the Pressure Swing Adsorption assembly. Other swing adsorptions can include vacuum pressure swing adsorption (VPSA), temperature swing adsorption (TSA), and/or electrical swing adsorption (ESA) assemblies, or any combination thereof. Typically, the adsorption assembly includes one or more vessels containing shaped solid phase adsorbent materials coupled and/or configured to work in concert to separate the carbon dioxide of incoming stream 16 from the nitrogen of the incoming stream 16. Adsorption materials can be characterized by breakthrough response as a function of time and/or with isotherm (constant temperature) curves which indicate capacity as a function of pressure. These characteristics can be used to determine material working capacity when configuring process step cycles. Adsorbent materials with high CO₂ capacity and high selectivity of CO₂ with respect to nitrogen and oxygen can be preferred.

Systems and/or methods can utilize adsorbent materials such as one or more of the following: activated carbons, carbon molecular sieves, natural and synthetic zeolites (i.e., alkali metal aluminosilicates), aluminophosphate materials, nanoporous framework compositions such as Metal Organic Framework structures (MOF's), and Covalent Organic Framework structures (COF's) and/or mesoporous silica with self-assembled ligands. Nanoporous framework compositions can include at least two classes of materials: 1. Metal Organic Framework (MOF's) containing polynuclear metal clusters bonded to Organic linkers; and 2. Covalent Organic Frameworks (COF's) containing polynuclear non-metal clusters bonded to organic linkers. Polynuclear clusters can be referred to as secondary building units (SBU's) which impart structure and rigidity to the framework material. Nanoporous Framework compositions can be further functionalized with specialized ligands associated with the clusters and/or linkers.

Carbonaceous adsorbents are available, low cost, have high thermal stability, and low sensitivity to moisture. These materials can be enhanced to improve surface area and pore structure, include amine compound functionalization, and/or amine compound impregnation.

Zeolite adsorbents can be low cost, have high thermal stability, and can have characteristics of exchange cations. These materials can be enhanced to improve Al/Si composition ratios and/or exchange with alkali and alkaline earth cations. CO₂ has a high linear quadrupole moment which interacts with intra-zeolite cations.

Mesoporous Silica can have high surface area, high pore volume, tunable pore size, and good thermal and mechanical stability. These materials can be enhanced to provide new families such as SBA-n and ABS, altered to include amine compound loading, and/or self-assembly of amine functionalized components into larger pore structures.

Metal Organic Frameworks (MOF's) and Covalent Organic Frameworks (COF's) can have high surface areas, controllable pore structures and/or pore surface properties. These materials can be constructed to provide new types of MOF's and COF's, reduce cost of synthesis and production, and/or improve stability towards water vapor.

In addition, all materials can be evaluated for specific functionalization such as chemical attachment and/or self-assembly of amine adorned ligands, and control of aluminum to silicon ratios in synthesized zeolites.

Adsorbent materials can include: Activated Carbon (AC), Carbon Molecular Sieve (CMS), 3A Zeolite (ex. Grace 564 3A); 4A Zeolite (ex. Grace 514 4A); 5A Zeolite (ex. BASF, Grace 522 5A SYLOBEAD); 13X Zeolite (ex. Grace 544 13X, BASF 13X, Zeochem Z10-02); 13X APG (ex. UOP MOLSIV 13X APG); 13X APG III (i.e., UOP MOLSIV APG III); and Jalon JLPM3 molecular sieve; Carbon NanoTubes (CNT); Graphene Supported Materials; LiLSX Zeolite (Lithium exchanged forms of LSX Zeolite, i.e., VSA-10); other cation exchanged materials; and nanoprous framework composition materials.

Additionally, one or more of these adsorbent materials can be performance enhanced. Particular materials, including enhanced materials, can lower the pressure or temperature required for PSA and TSA assemblies thus providing a system that requires less energy to operate. For example, mesoporous silica can be enhanced to include self-assembled functionalized amine ligands. Accordingly, synthetic porous materials can be modified for enhanced CO₂ working capacity and selectivity through one or more of the following changes:
a. Modification of the SI/AL ratio in Zeolite structures.
b. Selection of various metal cations in Zeolites.
c. Impregnation of Amine compounds within pores and cages.
d. Chemical attachment of amine ligands to surface features.
e. Self-assembly of amine ligands within pores (mesoporous silica).

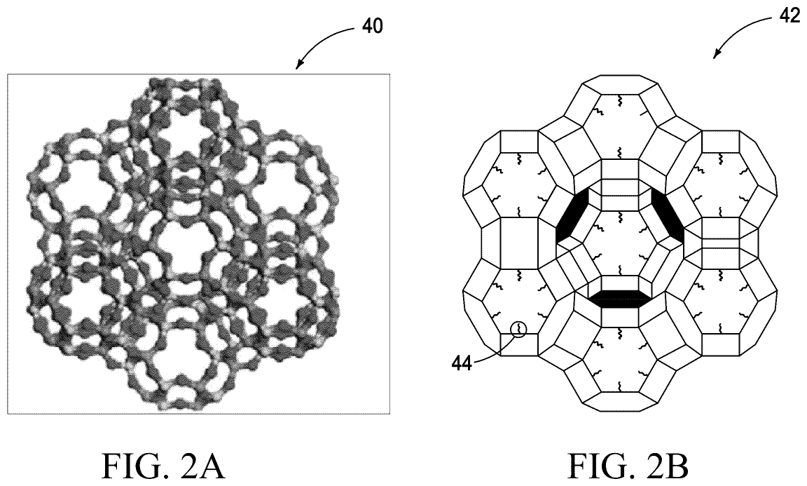

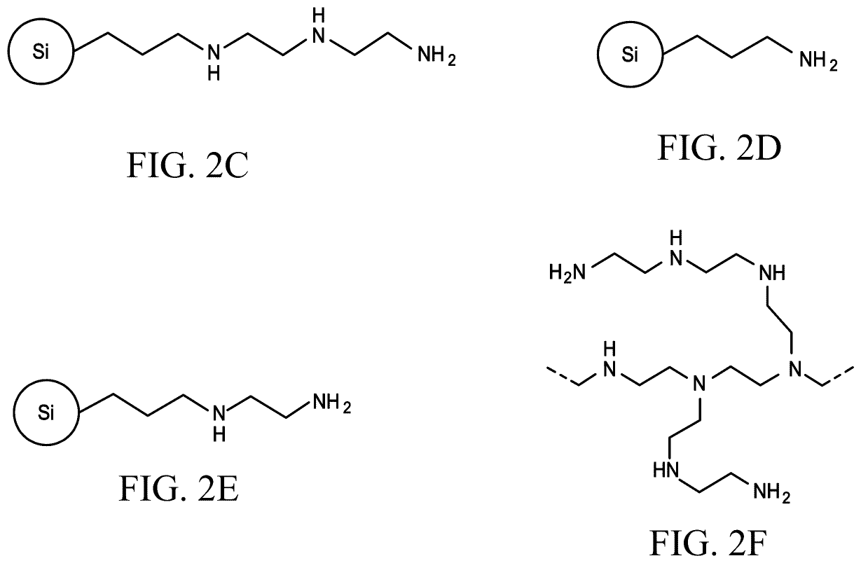

An example adsorbent configuration is provided that includes an example synthetic zeolites (i.e. alkali metal aluminosilicates) 40 as shown in FIG. 2A, with cage structures 42 as shown in FIG. 2B that could include amine functionality 44. Ligands can be attached to adsorbent surfaces, to pore fringes, or assembled within larger pores as in the case of mesoporous silica, for example. Examples of ligands with this amine functionality are given in FIGS. 2C-E. An example pore or cage impregnation compound is polyethylenimine (PEI) is shown in FIG. 2F. As can be seen, this amine functionality can extend to within the openings of the porous material, and this amine functionality can enhance the selectivity of trapping or retention of carbon dioxide in preference to or rather than nitrogen. Utilizing cyclic sorption and desorption in combination with weak molecular attractions, separation of CO2 and N2 can be achieved.

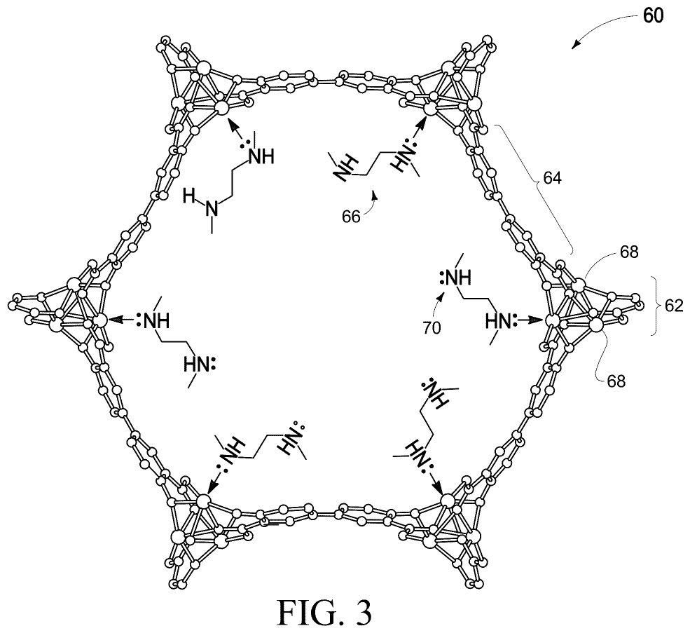

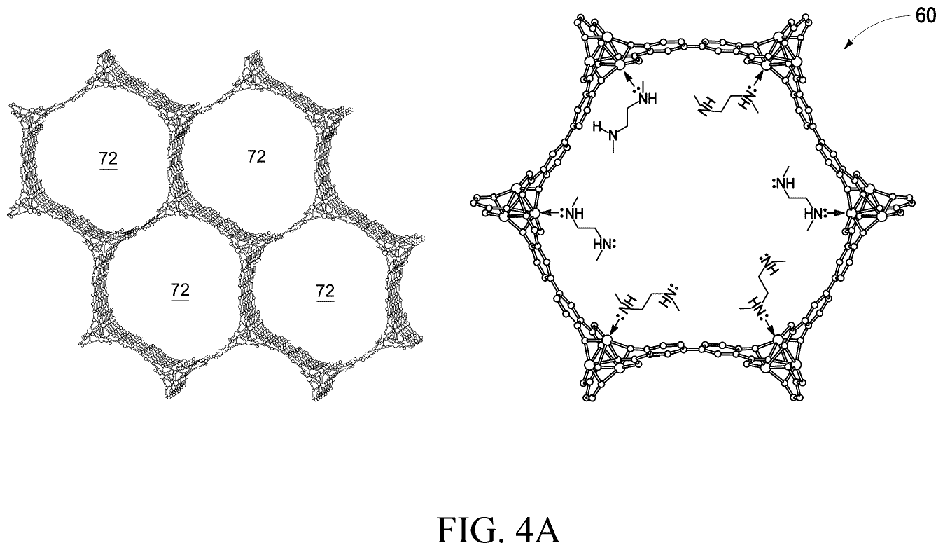

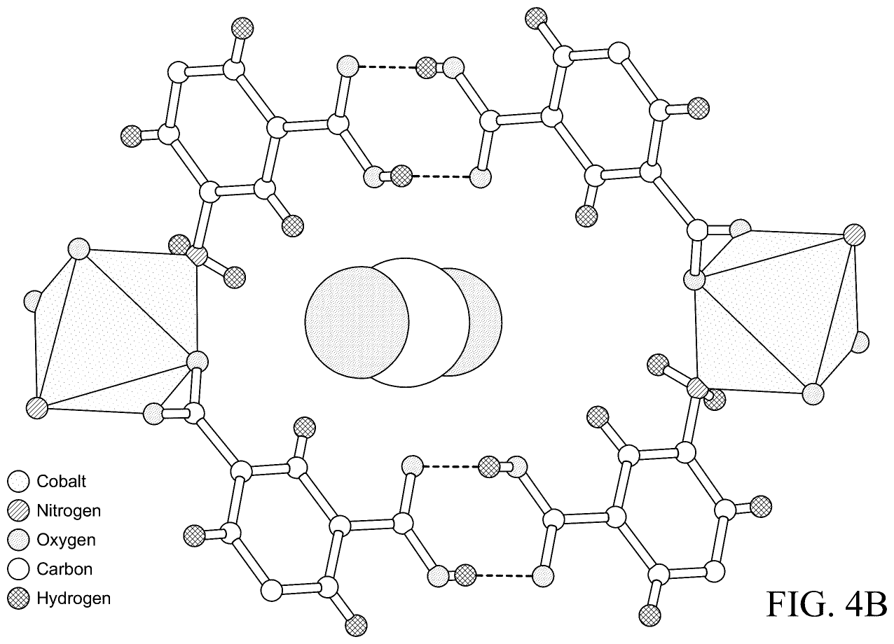

Referring to FIGS. 3, 4A, and 4B, nanoporous framework compositions are shown. These compositions can include metal organic compositions and/or structures for use as adsorbents within separation vessel(s). The nanoporous framework composition 60 can be configured as a metal organic framework or as a covalent organic framework. The nanoporous framework composition can include both clusters 62 and linkers 64. The clusters can include metals. The clusters can be considered secondary building units (SBU's) comprising poly-nuclear clusters 62 coupled by organic linkers 64. The SBU clusters can include either metal or non-metal elements 68, and provide structural rigidity to the framework.

As shown, composition 60 can include ligands 66 associated with one or both of clusters 62 and linkers 64. Ligand 66 can include at least one —NH— (i.e., amine) moiety 70. For example, ligand 66 can be CH₃NHCH₂CH₂NHCH₃ (dimethylethylenediamine). In accordance with example implementations, the lone pairs of the —NH— moiety can be associated with at least one of the metals 68 of nanoporous framework composition 60.

In FIG. 4B, for example, the MOF can define one-dimensional channels with approximate dimensions of 3.6×7.6 Å² throughout the framework. Pairs of ligands (Haip) can be connected by strong hydrogen bonds. Adsorption sites for CO₂ molecules are provided for in the pores of the MOF.

MOF materials can be prepared from inexpensive precursors; for example from isophthalic acid and its derivatives. The MOF can be built up from cobalt(II) ions and 5-aminoisophthalic acid by combining 5-aminoisophthalic acid (H₂aip) linker, with cobalt(II) salts in methanol to form [Co(Haip)₂].

The MOF material can crystalize in a monoclinic system with the I2/a space group. The framework can be of M(II) ions with an octahedral geometry lined up into a 1D chain. Adjacent chains can be pillared into two-dimensional (2D) sheets by the Haip ligands. The deprotonated carboxyl group of each Haip ligand can be coordinated to the cobalt ion, while the other engages in hydrogen bonding with a neighboring carboxyl group. This hydrogen-bonding array can connect the sheets in a three-dimensional (3D) supramolecular open framework featuring one-dimensional channels.

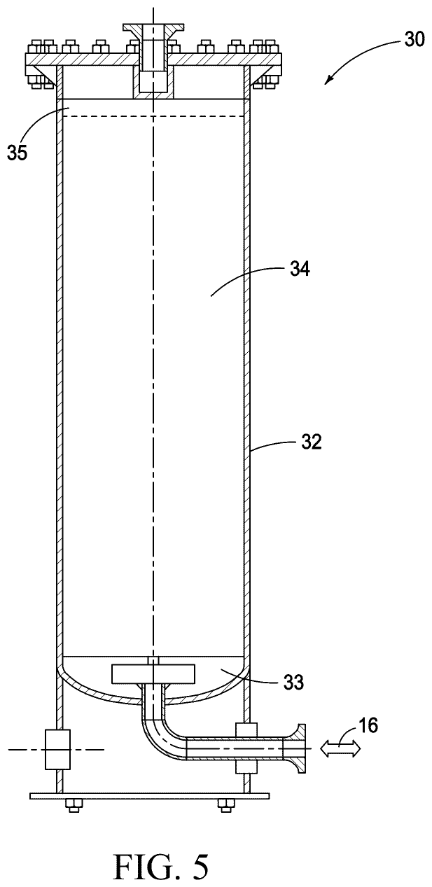

Referring next to FIG. 5, an example gas separation vessel bed layout is shown wherein stream 16 is entering the lower portion of the vessel 30 that includes sidewalls 32, and within vessel 30 can be a guard bed 33 which can include a layer of activated alumina configured to trap any remaining water vapor entering the system.

This guard bed can be about 8 inches in depth, which is underneath in relation to approximately a 49-inch layer of adsorbent 34. In accordance with example implementations, a top layer 35 above the adsorbent layer 34 can be provided that includes bed support media (ie. ¼″ Denstone beads) which can facilitate prevention of fluidization of the bed during operation. In accordance with example implementations, the vessel 30 can be configured to house at least 3 layers of material, a bottom layer 33, an adsorbent layer 34, and a top layer 35, with appropriately sized screen separators. In accordance with example implementations, the ratio of the depths of these layers can range from 8 inches of the bottom layer, 49 inches of the adsorbent layer, and 6.5 inches of the top layer.

In accordance with at least one particular implementation, 13X APG III adsorbent or JLPM3 adsorbent can be utilized in a multiple vessel (i.e., nine or twelve) vacuum pressure swing adsorption (VPSA) system with the vessel bed fill shown in FIG. 5. Three layers of functional material are shown. Accordingly, the bottom layer in each vessel can include activated alumina configured to capture any trace water vapor in the mixed gas input stream. Following a screen separator, the second layer can be defined by 49 inches of 13X APG III (specialized sodium metal aluminosilicate), or JLPM3 adsorbent configured for CO₂ separation from N₂. Following another screen separator, the top layer can be defined by 12 inches of bed support media (ie. Denstone) to prevent the bed from fluidizing. For all of these solid materials the optimum shapes (beads, rods, prills, etc.) and dimensions can be selected.

Stream 16 can be used to both charge and discharge vessel 32 and adsorbent 34. In accordance with example implementations, vessel 32 and adsorbent 34 can be charged with components of the combustion stream. These gaseous components can include at least CO₂ and N₂, but may also include O₂, as well as H₂O. Once charged, the material can be discharged in steps, and/or the discharge can be separated while monitoring discharge content. When charged, composition 60 can include CO₂. The CO₂ can be associated with one or both of ligand 66, metal 68, cluster 62, and/or linker 64. In accordance with example configurations, CO₂ can be within porous openings 72 of a MOF or COF framework structure. For example, initial discharge will contain more N₂ than CO₂ as the CO₂ is retained by the adsorbent to greater extent than N₂. This initial for first step discharge or waste stream can be provided for drying as discussed above, for example. Subsequent discharge will contain greater amounts of CO₂, for example, relatively N₂ free CO₂. Subsequent discharge or product stream obtained in the second step can be provided for liquefaction and/or storage. Multiple vessels have the same step cycle sequence adjusted in time relationship to provide continuous product separation.

In accordance with example implementations and with reference again to FIG. 1, separator 18 can be configured to separate nitrogen from carbon dioxide, leaving a product stream 20 of substantially pure carbon dioxide that can range in purity from at least 90% but as high as 98% to 100% when utilizing aluminosilicates such as 13X APG, 13X APG III and/or JLPM3. In accordance with at least one example implementation, 13X APG III or JLPM3 adsorbent can be loaded in the VPSA system. This adsorbent can perform at approximately 1.7 times the capacity of industry standard 13X materials. The cyclic pressure (vacuum) swing working window can be positioned for optimum performance in accordance with inflection on adsorbent isotherm curves.

In accordance with the system of FIG. 1, CO₂ output purity can be consistently >95% and CO₂ recovery can be >85%. Heat of adsorption can be transferred primarily to the output waste nitrogen stream. Thus, dryer bed regeneration is enhanced with the higher temperature nitrogen (>90 deg. F.) slip stream. In addition, product CO₂ output temperature can be lower in temperature (<90 deg F.) which complements the downstream liquefaction process of cooling and compression.

In accordance with example implementations, utilizing this particular material can generate a warm or even hot nitrogen waste stream 24 that can be split off and partially provided to dryer 14, which can enhance regeneration of desiccant dryer beds. Compressed nitrogen waste gas can also be expanded for energy recovery. In accordance with example configurations as well, this material has also been shown to provide substantially cooler or almost ambient temperature CO₂ 20 to liquefier 22 which greatly lessens the energy required to condense the carbon dioxide to a liquid phase in liquefier 22.

Systems and/or methods of the present disclosure can reduce carbon dioxide emissions into the atmosphere while producing a valuable product which can be sequestered in concrete (carbonates), utilized in production of carbon neutral fuels (eFuels), platform chemicals, support waste water treatment, and a variety of other beneficial applications.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

1. A system for recovering CO₂ from a combustion gas stream, the system comprising:
a combustion stream comprising CO₂ and N₂;
a vessel operatively coupled to the combustion stream, the vessel containing a nanoporous framework composition associated with a ligand; and
a vessel outlet stream operatively engaged with the vessel.

2. The system of claim 1 wherein the nanoporous framework composition comprises a metal organic composition.

3. The system of claim 2 wherein the metal organic composition comprises a metal organic framework (MOF).

4. The system of claim 2 wherein the nanoporous framework composition comprises clusters coupled by linkers, wherein the clusters comprise metal elements.

5. The system of claim 4 wherein the ligands are associated with one or both of the clusters and linkers.

6. The system of claim 1 wherein the nanoporous framework composition comprises clusters coupled by linkers and the clusters are non-metal.

7. The system of claim 6 wherein the clusters are covalently linked to the linkers.

8. The system of claim 1 wherein the ligand comprises at least one —NH— moiety.

9. The system of claim 8 wherein the ligand comprises CH₃NHCH₂CH₂NHCH₃.

10. The system of claim 8 wherein the lone pairs of the —NH— moiety are associated with the clusters or linkers of the nanoporous framework composition.

11. A composition comprising:
a nanoporous framework composition;
a ligand associated with the nanoporous framework composition; and
CO₂ associated with the one or both of the ligand and the nanoporous framework composition.

12. The composition of claim 11 wherein the nanoporous framework composition comprises a metal organic framework.

13. The composition of claim 12 wherein the metal organic framework comprises clusters coupled by linkers, wherein the clusters comprise metal elements.

14. The composition of claim 13 wherein the ligands are associated with one or both of the clusters and linkers.

15. The composition of claim 11 wherein the ligand comprises at least one —NH— moiety.

16. The composition of claim 15 wherein the ligand comprises CH₃NHCH₂CH₂NHCH₃.

17. The composition of claim 15 wherein the lone pairs of the —NH— moiety are associated with the clusters or linkers of the nanoporous framework composition.

18. A method for separating CO₂ from a combustion stream, the method comprising:
charging a vessel containing a nanoporous framework composition with components of a combustion stream, at least two of the components comprising CO₂ and N₂;
discharging in the first of at least two steps, at least some of the N₂ while retaining CO₂ associated with the metal organic composition; and
discharging in a second of the at least two steps, at least some of the retained CO₂ to a provide a stream of CO₂ substantially free of N₂.

19. The method of claim 18 wherein the combustion stream comprises the CO₂ and the N₂ and O₂.

20. The method of claim 18 wherein the nanoporous framework composition comprises a metal organic framework associated with a plurality of ligands, the method comprising associating the CO₂ with one or both the metal organic framework and/or the ligand.

21. The method of claim 20 wherein the metal organic framework is comprised of clusters associated by linkers, the CO₂ being associated with one or both the clusters and/or linkers.

22. The method of claim 20 wherein the nanoporous framework composition comprises clusters and linkers.

23. The method of claim 20 wherein the CO₂ is associated with a —NH— moiety of the ligand.

24. The method of claim 18 wherein the combustion stream is substantially free of water.

25. A system for recovering CO₂ from a combustion gas stream, the system comprising:
a combustion stream comprising CO₂ and N₂;
a vessel operatively coupled to the combustion stream, the vessel containing material comprising one or more of activated carbons, carbon molecular sieves, carbon nanotubes, natural and synthetic zeolites (i.e., alkali metal aluminosilicates), aluminophosphate materials, and/or mesoporous silica; and
a vessel outlet stream operatively engaged with the vessel.

26. The system of claim 25 wherein the material further comprises self assembled ligands.

27. The system of claim 26 wherein the ligands are coupled to the material.

28. The system of claim 26 wherein the ligands comprise Si.

29. The system of claim 26 wherein the ligands comprise —NH— moiety.

30. A method for separating CO₂ from a combustion stream, the method comprising:
charging a vessel with components of a combustion stream, at least two of the components comprising CO₂ and N₂; and the vessel containing a material comprising one or more of activated carbons, carbon molecular sieves, carbon nanotubes, natural and synthetic zeolites (i.e., alkali metal aluminosilicates), aluminophosphate materials, and/or mesoporous silica;
discharging in the first of at least two steps, at least some of the N₂ while retaining CO₂ associated with the metal organic composition; and
discharging in a second of the at least two steps, at least some of the retained CO₂ to a provide a stream of CO₂ substantially free of N₂.

31. The method of claim 30 wherein the material further comprises self assembled ligands.

32. The method of claim 31 wherein the ligands are coupled to the material.

33. The method of claim 31 wherein the ligands comprise Si.

34. The method of claim 31 wherein the ligands comprise —NH— moiety.

35. The method of claim 30 wherein the combustion stream is substantially free of water.
